(19) United States
(12) Patent Application Publication
(10) Pub. No.: US 2004/0045417 A1
(43) Pub. Date: Mar. 11, 2004

(54) Handgrip structure for fixing angled socket

(76) Inventor: Li Jiun Chiu, Taichuang (TW)

Correspondence Address: Li jiun Chiu, P.O. BOX 65-45, Taichuang, 403, TW

(21) Appl. No.: 10/237,895

(22) Filed: Sep. 10, 2002

(51) Int. Cl. B25B 23/16

(52) U.S. Cl. 81/177.6

(57) ABSTRACT

A grip structure for fixing an angled socket includes a first cover, a second cover, a first nut, and a second nut. The first cover and the second cover are combined with each other by the first nut and the second nut to encompass the outer periphery of the angled socket, so as to function a grip of the angled socket.

### BACKGROUND OF THE INVENTION

1. Field of the Invention

The present invention relates to a grip structure for fixing an angled socket, and more particularly to a grip structure for fixing an angled socket, so that the user may use the angled socket to operate the workpiece easily and conveniently.

2. Description of the Related Art

A conventional angled socket structure 1 in accordance with the prior art shown in FIGS. 1 and 2 is disclosed in the Taiwanese Patent Publication No. 450158, and comprises a drive body 11, a driven body 12, an L-shaped linking bar 13 mounted between the drive body 11 and the driven body 12, and multiple L-shaped drive bars 14 mounted between the drive body 11 and the driven body 12. The drive body 11 has a center formed with a linking hole 111 and multiple mounting holes 112 arranged around a periphery of the linking hole 111. The drive body 11 has one end formed with an insertion hole 113 communicating with the linking hole 111 for insertion of pins 15. The driven body 12 has a center formed with a linking hole 121 and multiple mounting holes 122 arranged around a periphery of the linking hole 121. The driven body 12 has one end formed with an insertion hole 123 communicating with the linking hole 121 for insertion of pins 15. The L-shaped linking bar 13 has two ends each formed with a locking groove 131. Each of the two ends of the L-shaped linking bar 13 is inserted into one of the linking hole 111 of the drive body 11 and the linking hole 121 of the driven body 12, and each of the pins 11 is inserted into one of the insertion hole 113 of the drive body 11 and the insertion hole 123 of the driven body 12, and is inserted into the locking groove 131 of one of the two ends of the L-shaped linking bar 13, so that the drive body 11, the L-shaped linking bar 13 and the driven body 12 are combined with each other. Each of the multiple L-shaped drive bars 14 has two ends each inserted into one of the mounting holes 112 of the drive body 11 and one of the mounting holes 122 of the driven body 12. When the drive body 11 is rotated, each of the multiple L-shaped drive bars 14 may be moved with rotation of the drive body 11, thereby forming a rotation driving force to drive the driven body 12 to rotate synchronously.

In operation, the drive body 11 may be combined with a pneumatic tool or a motorized tool, and the driven body 12 may be combined with socket or a driver head. Thus, the drive body 11 may be rotated by the pneumatic tool or motorized tool to simultaneously rotate the driven body 12 and the socket or driver head by using the multiple L-shaped drive bars 14. In such a manner, the socket or driver head may be used to operate a workpiece in a corner or gap having a smaller space by using the bent angle of the angled socket structure.

Thus, when the driven body 12 is rotated by the drive body 11, the multiple L-shaped drive bars 14 are also driven to rotate. However, the L-shaped linking bar 13 and the multiple L-shaped drive bars 14 are exposed to the ambient environment, so that the user cannot hold the multiple L-shaped drive bars 14 to position the angled socket structure, and has to additionally provide a tool for positioning the angled socket structure, thereby causing inconvenience to the user in operation.

### SUMMARY OF THE INVENTION

The present invention has arisen to mitigate and/or obviate the disadvantage of the conventional angled socket structure.

The primary objective of the present invention is to provide a grip structure for fixing an angled socket, wherein the first cover and the second cover are combined with each other by the first nut and the second nut to encompass the outer periphery of the angled socket, so as to function a grip of the angled socket.

Another objective of the present invention is to provide a grip structure for fixing an angled socket, wherein the grip structure is mounted on the outer periphery of the angled socket for fixing the position of the angled socket exactly, so that the user may use the angled socket to operate the workpiece easily and conveniently.

In accordance with the present invention, there is provided a grip structure in combination with an angled socket, comprising: an angled socket, a first cover, a second cover, a first nut, and a second nut, wherein:

the angled socket includes a drive body formed with an annular groove, and a driven body formed with an annular groove;

the first cover and the second cover are combined with each other to encompass an outer periphery of the angled socket, each of the first cover and the second cover has two ends each provided with an inner flange inserted into and combined with the annular groove of each of the drive body and the driven body of the angled socket; and

each of the first nut and the second nut is secured on one of the two ends each of the first cover and the second cover, so that the first cover and the second cover are fixed to encompass the outer periphery of the angled socket, so as to function a grip of the angled socket.

Preferably, each of the two ends of the first cover is provided with an outer threaded section, each of the two ends of the second cover is provided with an outer threaded section, and each of the first nut and the second nut is formed with an inner threaded section screwed on the outer threaded section of one of the two ends of each of the first cover and the second cover.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional angled socket structure in accordance with the prior art;

FIG. 2 is a plan cross-sectional assembly view of the conventional angled socket structure as shown in FIG. 1;

FIG. 3 is an exploded perspective view of a grip structure for fixing an angled socket in accordance with a first embodiment of the present invention;

FIG. 4 is a side plan cross-sectional assembly view of the grip structure for fixing an angled socket as shown in FIG. 3;

FIG. 5 is a perspective assembly view of the grip structure for fixing an angled socket as shown in FIG. 3;

FIG. 6 is a schematic plan operational view of the grip structure for fixing an angled socket as shown in FIG. 5 in use;

FIG. 7 is a side plan cross-sectional assembly view of a grip structure for fixing an angled socket in accordance with a second embodiment of the present invention; and

FIG. 8 is a schematic plan operational view of the grip structure for fixing an angled socket as shown in FIG. 7 in use.

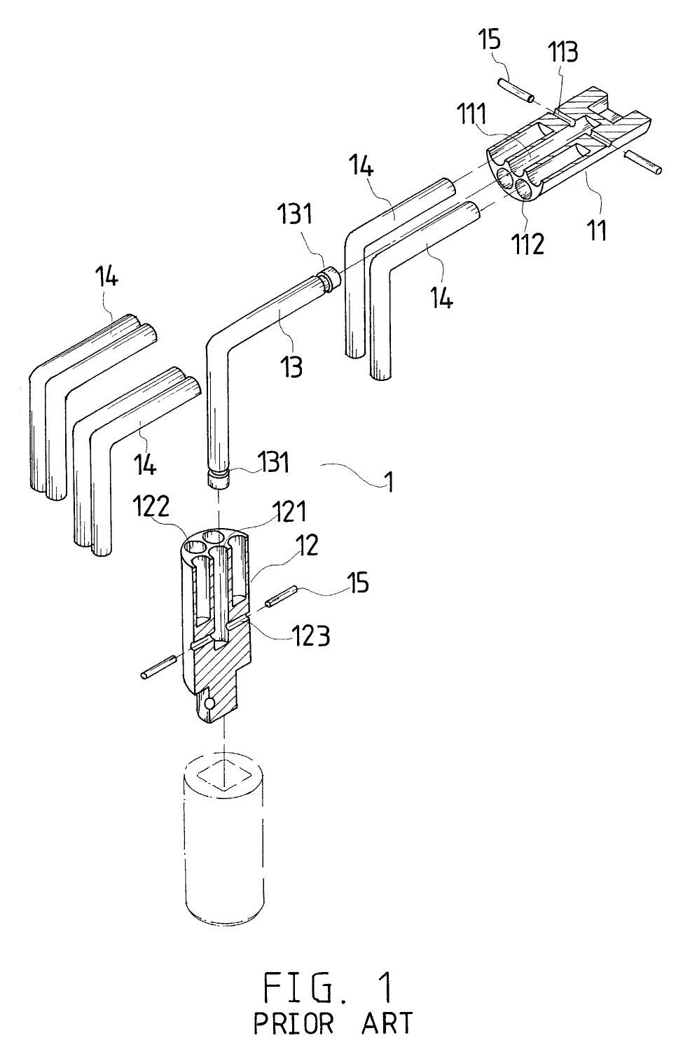

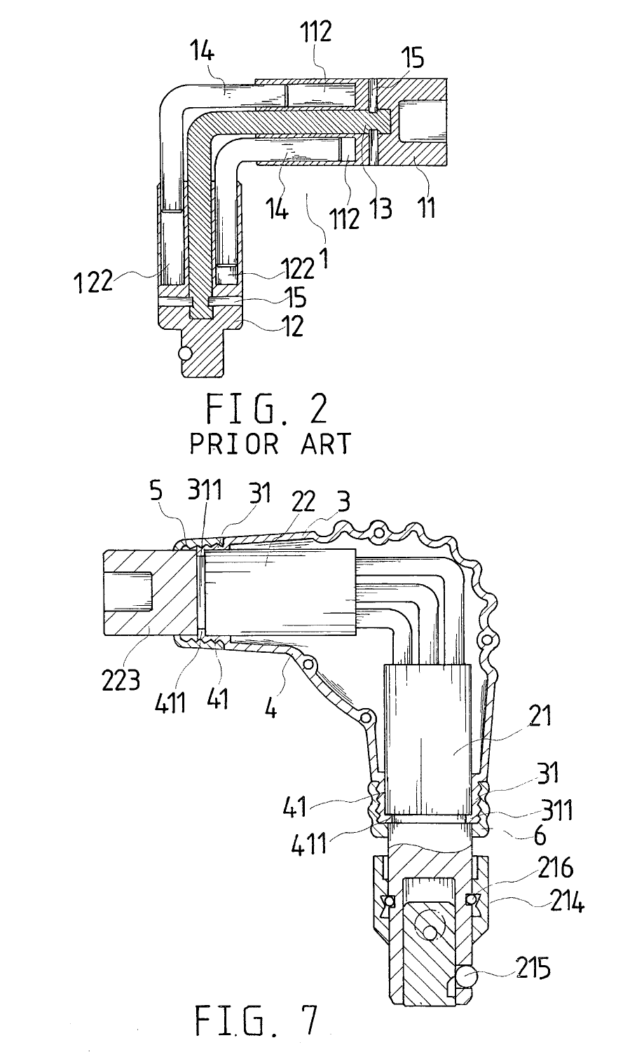

### DETAILED DESCRIPTION OF THE INVENTION

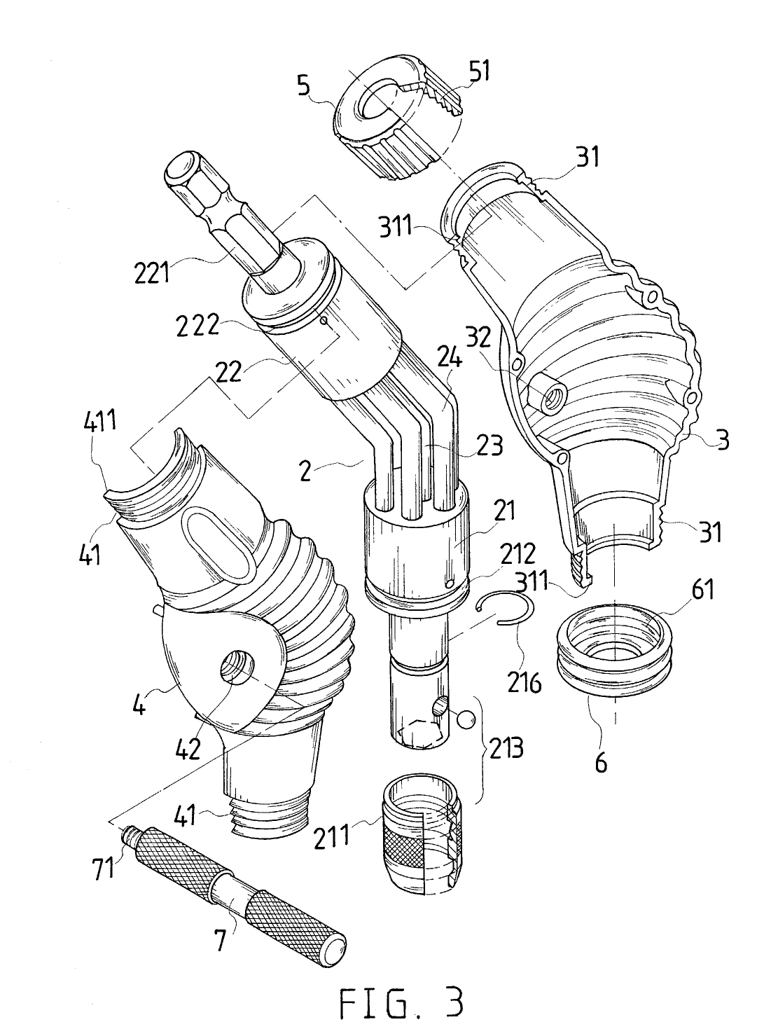

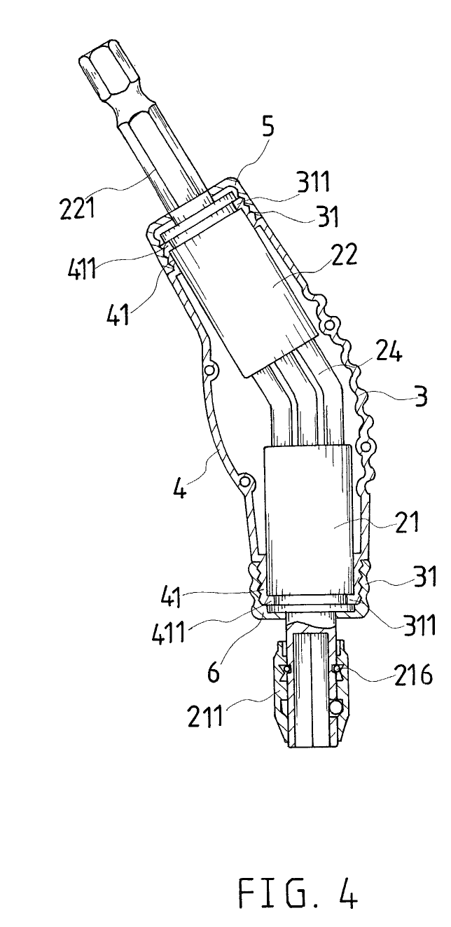

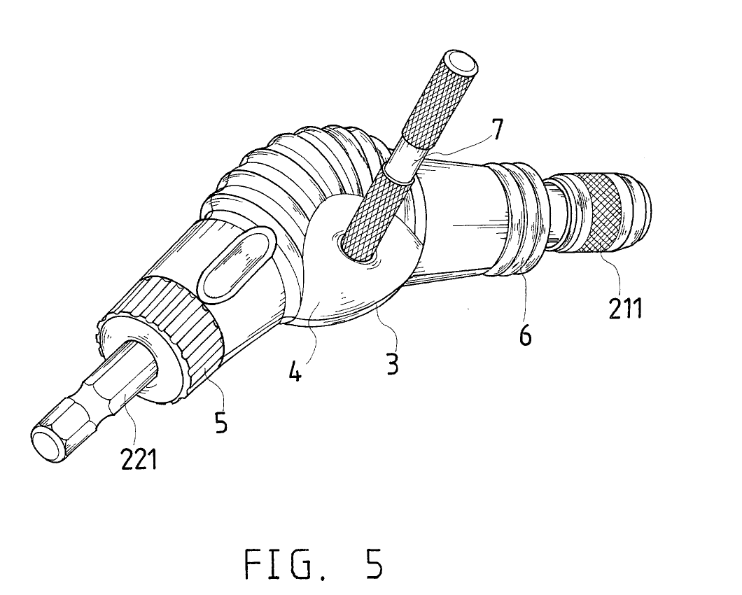

Referring to the drawings and initially to FIGS. 3-5, a grip structure for fixing an angled socket 2 in accordance with a first embodiment of the present invention comprises a first cover 3, a second cover 4, a first nut 5, a second nut 6, and a holding bar 7.

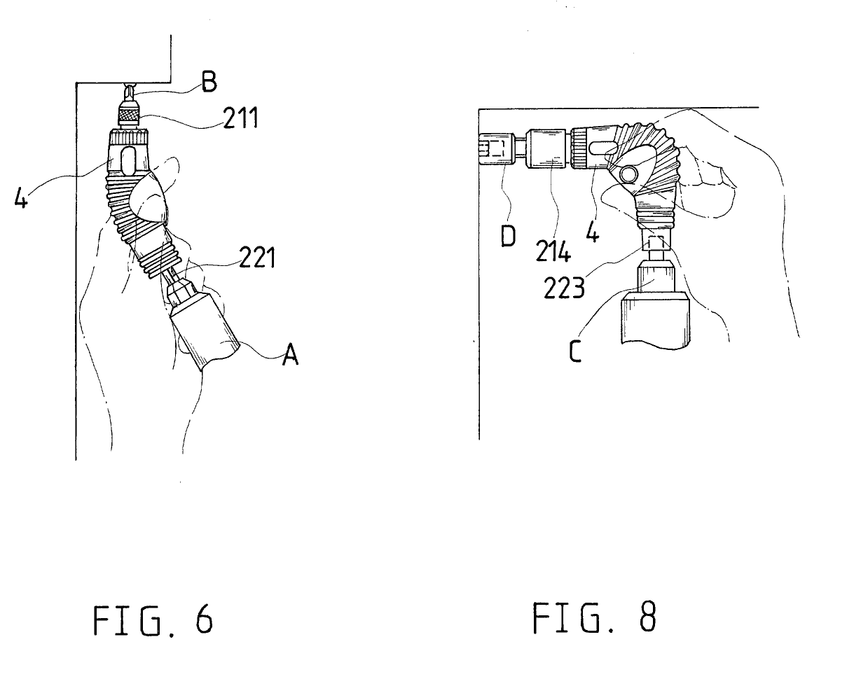

The angled socket 2 is bent with an included angle of 150 degrees. The angled socket 2 includes a driven body 21, a drive body 22, a linking bar 23 mounted between the driven body 21 and the drive body 22, and multiple drive bars 24 mounted between the driven body 21 and the drive body 22. The drive body 22 has a distal end combined with a combination terminal 221 that may be combined with a pneumatic tool or a motorized tool. The drive body 22 is formed with an annular groove 222. The driven body 21 has a distal end combined with a quick connector 211 by a C-shaped snap ring 216. The driven body 21 is formed with an annular groove 212. The quick connector 211 contains a fixing structure 213 that may be fixed on or released from a driver head “B” (see FIG. 6), so that the quick connector 211 may be fixed on or released from the driver head “B” (see FIG. 6).

The first cover 3 has a bent angle that mates with the bent angle of the angled socket 2. The first cover 3 has two ends each provided with an outer threaded section 31 which has a distal end provided with an inner flange 311. The first cover 3 has a mediate portion formed with an inner threaded through hole 32.

The second cover 4 has a bent angle that mates with the bent angle of the first cover 3. The second cover 4 has two ends each provided with an outer threaded section 41 which aligns with the outer threaded section 31 of the first cover 3 and has a distal end provided with an inner flange 411 aligning with the inner flange 311 of the outer threaded section 31 of the first cover 3. The second cover 4 has a mediate portion formed with an inner threaded through hole 42 which aligns with the inner threaded through hole 32 of the first cover 3.

The first nut 5 is formed with an inner threaded section 51.

The second nut 6 is formed with an inner threaded section 61.

The holding bar 7 has one end formed with an outer threaded section 71 that may be screwed into the inner threaded through hole 32 of the first cover 3 or the inner threaded through hole 42 of the second cover 4, so that the holding bar 7 may be combined with the first cover 3 or the second cover 4 in a perpendicular manner.

In assembly, referring to FIGS. 3-5, the first cover 3 and the second cover 4 are mounted on a periphery of the angled socket 2. At this time, the inner flange 311 of the outer threaded section 31 of each of the two ends of the first cover 3 and the inner flange 411 of the outer threaded section 41 of each of the two ends of the second cover 4 are respectively inserted into the annular groove 222 of the drive body 22 and the annular groove 212 of the driven body 21, so that the first cover 3 and the second cover 4 may be retained on the periphery of the angled socket 2.

Then, the first nut 5 and the second nut 6 are mounted on the two ends of the angled socket 2, and the inner threaded section 51 of the first nut 5 and the inner threaded section 61 of the second nut 6 are screwed on the outer threaded section 31 of each of the two ends of the first cover 3 and the outer threaded section 41 of each of the two ends of the second cover 4, thereby fixing each of the two ends of the first cover 3 and each of the two ends of the second cover 4, so that the first cover 3 and the second cover 4 may be combined and fixed on the periphery of the angled socket 2, so as to encompass the angled socket 2. Thus, the first cover 3 and the second cover 4 may function as a grip of the angled socket 2. In addition, the outer threaded section 71 of the holding bar 7 may be screwed into the inner threaded through hole 32 of the first cover 3 or the inner threaded through hole 42 of the second cover 4, so that the holding bar 7 may be combined with the first cover 3 or the second cover 4 in a perpendicular manner.

In use, referring to FIG. 6 with reference to FIGS. 3-5, the combination terminal 221 of the drive body 22 of the angled socket 2 may be combined with a motorized tool “A”, and the quick connector 211 of the driven body 21 of the angled socket 2 may be combined with a driver head “B” by the fixing structure 213. Thus, when the combination terminal 221 of the drive body 22 of the angled socket 2 is rotated, the drive bars 24 may be driven to drive the driven body 21 and the quick connector 211 of the driven body 21 to rotate, so that the driver head “B” fixed on the quick connector 211 of the driven body 21 of the angled socket 2 may also be rotated simultaneously. At this time, the user's one hand may hold the grip of the angled socket 2 formed by the first cover 3 and the second cover 4 so as to fix the position of the angled socket 2, thereby facilitating operation of the driver head “B” in a corner or gap having a smaller space by using the bent angle of the angled socket 2. In addition, the holding bar 7 may function as an auxiliary tool, so that the user may hole the holding bar 7 to fix the position of the angled socket 2 exactly.

Referring to FIGS. 7 and 8, a grip structure for fixing an angled socket 2 in accordance with a second embodiment of the present invention is shown, wherein each of the angled socket 2, the first cover 3 and the second cover 4 has a bent angle equal 90 degrees.

The drive body 22 of the angled socket 2 may be combined with a socket terminal 223 that may be combined with a pneumatic tool “C”. In addition, the driven body 21 of the angled socket 2 may be combined with a quick connector 214 that may be combined with a socket head “D”. The quick connector 214 has a fixing structure 215 including a ball mating with a slide cylinder, so that the quick connector 214 may be combined with or released from the socket head “D”.

Accordingly, the grip structure in accordance with the present invention is mounted on the outer periphery of an angled socket for keeping and fixing the position of the angled socket exactly, so that the user may use the angled socket to operate the workpiece easily and conveniently.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A grip structure in combination with an angled socket, comprising:
an angled socket, a first cover, a second cover, a first nut, and a second nut, wherein:
the angled socket includes a drive body formed with an annular groove, and a driven body formed with an annular groove;
the first cover and the second cover are combined with each other to encompass an outer periphery of the angled socket, each of the first cover and the second cover has two ends each provided with an inner flange inserted into and combined with the annular groove of each of the drive body and the driven body of the angled socket; and
each of the first nut and the second nut is secured on one of the two ends each of the first cover and the second cover, so that the first cover and the second cover are fixed to encompass the outer periphery of the angled socket, so as to function a grip of the angled socket.

2. The grip structure for fixing an angled socket in accordance with claim 1, wherein each of the two ends of the first cover is provided with an outer threaded section, each of the two ends of the second cover is provided with an outer threaded section, and each of the first nut and the second nut is formed with an inner threaded section screwed on the outer threaded section of one of the two ends of each of the first cover and the second cover.

3. The grip structure for fixing an angled socket in accordance with claim 1, further comprising a holding bar combined with the first cover.

4. The grip structure for fixing an angled socket in accordance with claim 3, wherein the first cover is formed with an inner threaded through hole, and the holding bar has one end formed with an outer threaded section that may be screwed into the inner threaded through hole of the first cover.

5. The grip structure for fixing an angled socket in accordance with claim 1, further comprising a holding bar combined with the second cover.

6. The grip structure for fixing an angled socket in accordance with claim 5, wherein the second cover is formed with an inner threaded through hole, and the holding bar has one end formed with an outer threaded section that may be screwed into the inner threaded through hole of the second cover.
